(19) United States
(12) Patent Application Publication
(10) Pub. No.: US 2025/0296486 A1
(43) Pub. Date: Sep. 25, 2025

(54) AIR DISTRIBUTION DEVICE

(71) Applicant: GENTHERM INCORPORATED, Northville, MI (US)

(72) Inventors: Timothy Normand, LaSalle (CA); Daniel Wei Li Cheah, Belle River (CA); Hua Wei Lin, Windsor (CA)

(21) Appl. No.: 18/863,366

(22) PCT Filed: Jun. 27, 2023
(86) PCT No.: PCT/US2023/026274

§ 371 Date: Nov. 6, 2024

Related U.S. Application Data
(60) Provisional application No. 63/356,763, filed on Jun. 29, 2022.

(51) Int. Cl. B60N 2/56

(52) U.S. Cl. CPC B60N 2/5657; B60N 2/5635

(57) ABSTRACT

An air distribution device for a vehicle seat, that includes: a top cover comprising one or more ports; a bottom cover connected to the top cover to form a housing, the bottom cover comprising an opening; and an air moving device comprising an impeller, the impeller being located in the housing between the top cover and the bottom cover; air is drawn into the housing by the air moving device through the opening in the bottom cover and then exhausted from the housing through the one or more ports in the top cover.

### CROSS-REFERENCE TO RELATED APPLICATIONS

This application claims priority to U.S. 63/356,763 filed Jun. 29, 2022, the entirety of which is hereby incorporated by reference herein for all purposes.

### FIELD

These teachings relate to an air distribution device and to a vehicle seat having an air distribution device.

### BACKGROUND

Some vehicle seats include one or more features for enhancing occupant comfort.

For example, some vehicle seats include one or more conditioning systems for directing warm, cool, and/or ambient air towards or away from an occupant of the vehicle seat. Such conditioning systems may include an air moving device and an air distribution device that is configured to distribute or collect an airflow generated by the air moving device.

While some of the currently available conditioning systems are suitable for their intended purpose, it may be desirable to improve the current state of the art.

For example, some air moving devices are connected to an air distribution device via one or more hoses, ducts, and/or clamps. It may be desirable to have an improved air distribution device that does not require one or more hoses, ducts, or clamps to connect the air moving device to the air distribution device. Instead, for example, it may be desirable to have an air moving device that connects directly to the air distribution device and/or an air moving device that includes an integral air distribution device. Having such an air distribution device may have numerous advantages including reducing product assembly time, weight, and packaging space.

Some air distribution devices include a housing with one or more layers inside of the housing. The one or more inside layers may be configured or designed to prevent the housing from collapsing under the weight of an occupant or object in the vehicle seat. It may be desirable to have an improved air distribution device with a housing that is free of such internal layers. Having such an air distribution device may have numerous advantages including, for example, reducing product assembly time, weight, cost, and packaging space.

### SUMMARY

These teachings provide an air distribution device. The air distribution device may be added or incorporated into the construction of a vehicle seat. The air distribution device may include a cover comprising one or more ports; an opposing cover connected to the cover to form a housing, the opposing cover comprising an opening; and an air moving device comprising an impeller, the impeller being located in the housing between the cover and the opposing cover; wherein air is drawn into the housing by the air moving device through the opening in the opposing cover and then exhausted from the housing through the one or more ports in the cover.

These teachings provide an air distribution device for a vehicle seat, comprising: a cover comprising one or more ports; an opposing cover connected to the cover to form a housing, the opposing cover comprising an opening; and an air moving device comprising an impeller, the impeller being located at least partially in the housing between the cover and the opposing cover and at least partially below the opposing cover; wherein air is drawn into the housing by the air moving device through the one or more ports in the cover and then exhausted from the housing through the opening in the opposing cover.

The cover and/or the opposing cover described herein may also be referred to herein as a bottom cover, a top cover, a side cover, an opposing side cover, or a combination thereof. The description of the cover may be based on the orientation of the air distribution device before or after the air distribution device is added to or installed in the vehicle seat or other installation location.

### BRIEF DESCRIPTION OF THE DRAWINGS

FIG. 1 is a side view of a vehicle.

FIG. 2 is a perspective view of a vehicle seat.

FIG. 3 is a top or front perspective view of an air distribution device.

FIG. 4 is a bottom or back perspective view of the air distribution device of FIG. 3.

FIG. 5 is an exploded perspective view of the air distribution device of FIGS. 3 and 4.

FIG. 6 is a perspective view of the outside of the top or front cover of the air distribution device of FIGS. 3 and 4.

FIG. 7 is a perspective view of the inside of the top or front cover of the air distribution device of FIGS. 3 and 4.

FIG. 8 is a perspective view of the inside of the bottom or back cover of the air distribution device of FIGS. 3 and 4.

FIG. 9 is a perspective view of the outside of the bottom or back cover of the air distribution device of FIGS. 3 and 4.

FIG. 10 is a cross-sectional view of the air distribution device of FIGS. 3 and 4.

FIG. 11 is a cross-sectional view of the air distribution device of FIGS. 3 and 4 installed in a vehicle seat.

FIG. 12 is a top or front perspective view of an air distribution device.

FIG. 13 is a bottom or back perspective view of the air distribution device of FIG. 12.

FIG. 14 is an exploded perspective view of the air distribution device of FIGS. 12 and 13.

FIG. 15 is a perspective cross-sectional view of the air distribution device of FIGS. 12 and 13.

FIG. 16 is a top or front perspective view of an air distribution system.

FIG. 17 is a bottom or back perspective view of the air distribution system of FIG. 16.

FIG. 18 is an exploded perspective view of the air distribution device of FIGS. 16 and 17.

FIG. 19 is an exploded perspective view of the air distribution device of FIGS. 16 and 17.

FIG. 20 is a cross-sectional view of the air distribution device of FIGS. 16 and 17

FIG. 21 a top or front perspective view of an air distribution device.

FIG. 22 a bottom or back perspective view of an air distribution device.

FIG. 23 is a perspective view of the outside of the housing of the air distribution device of FIGS. 21 and 22.

FIG. 24 is a perspective view of the inside of the housing of the air distribution device of FIGS. 21 and 22.

FIG. 25 is a perspective view of an air distribution device.

FIG. 26 is a perspective view of the air distribution device of FIG. 25.

### DETAILED DESCRIPTION

These teachings provide an air distribution device. The air distribution device is illustrated and described herein with reference to the accompanying drawings. It is understood that the accompanying drawings are merely exemplary in nature and are provided to explain the structure, elements, and features of the air distribution device and their associated function. In this regard, features or elements illustrated and described in the drawings may be rearranged, eliminated, duplicated, and or reconfigured, and still be within the scope of the teachings. Moreover, it is contemplated that one or more features or elements from one exemplary drawing may be duplicated, rearranged, and/or reconfigured and then added to other features in another drawings. In this regard, the orientation, placement, and or size of features or elements in the drawing should not be viewed as a rigid requirement. Further, unless otherwise noted, a description relating to the structure and/or function of a feature in one figure may apply to the structure and/or function of a related feature in another figure.

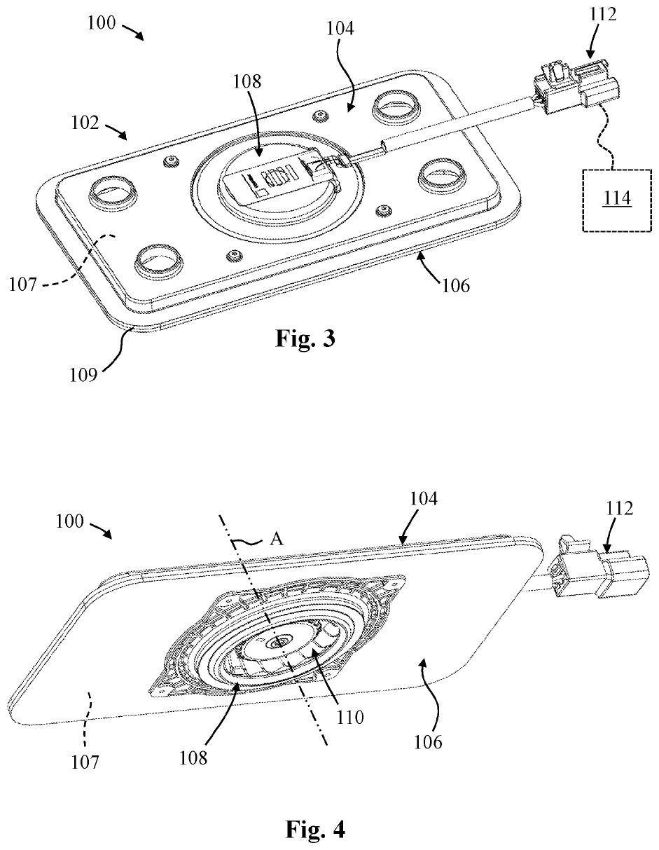

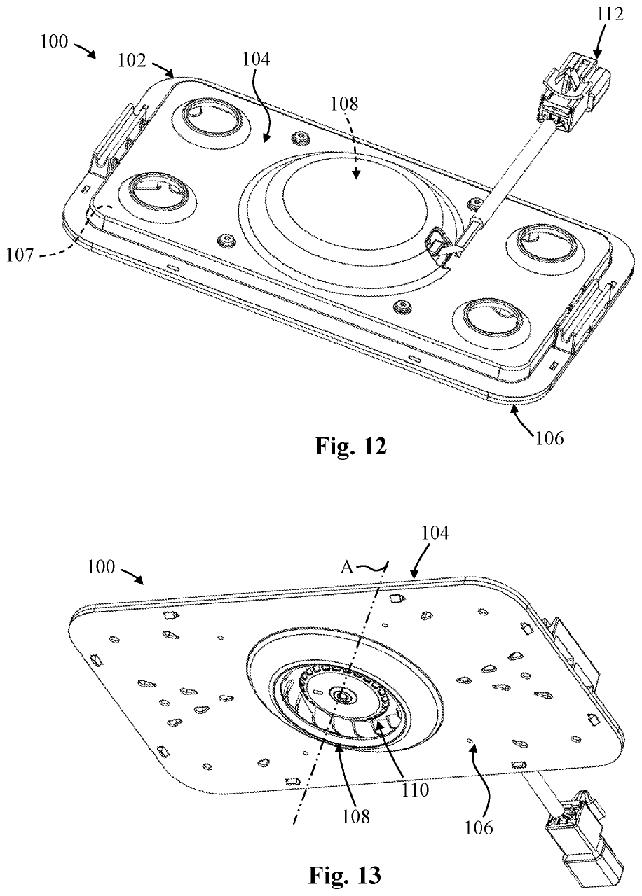

It should also be understood that a top cover or layer of any of the air distribution devices disclosed herein may be substituted with another illustrated and/or described top cover or layer of any air distribution device. Similarly, a bottom cover or layer of any air distribution device may be substituted with another illustrated and/or describe bottom cover or layer of any air distribution device. A non-limiting example of this is the top cover or layer 104 illustrated and described at FIG. 3 may be substituted with the top cover or layer 104 illustrated and described at FIG. 12 and vice versa. The same applies for any of the air movers. Moreover, while a layer or cover is described as being a “top”, it is understood the same cover or layer may be a “bottom” and this may be dependent on the orientation of the air distribution device before or after installation in the final location, such as the vehicle seat or any other conditioned seat (i.e., a non-vehicular seat).

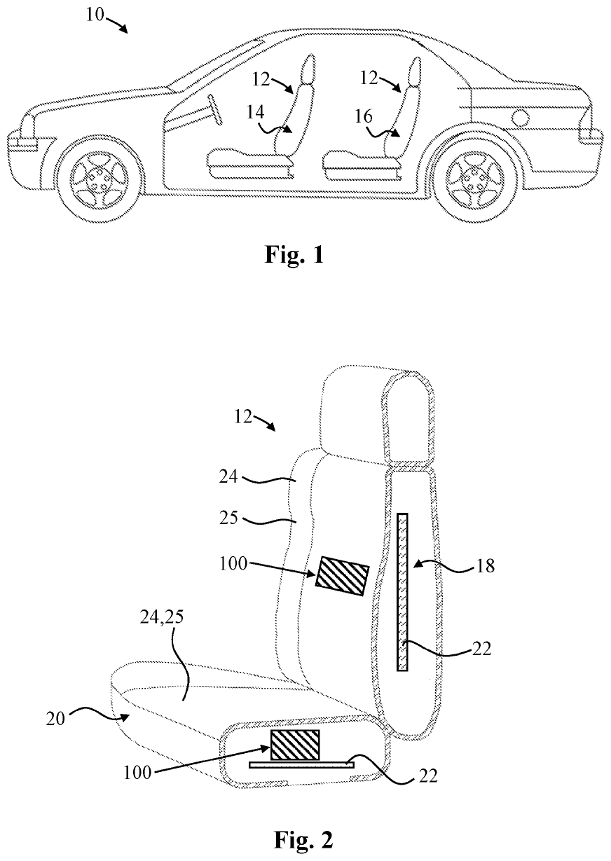

FIG. 1 illustrates a vehicle 10. The vehicle 10 includes a seat 12. The seat 12 may be a front vehicle seat 14. The vehicle seat 12 may be a rear vehicle seat 16. While the description herein focuses on the incorporation of an air distribution device into a vehicle seat, it is understood that the air distribution device may also or may instead be added or installed in a non-vehicular seat, such as an office chair, wheelchair, couch, sofa, recliner, bed, or other seating support device. Further, while the teachings focus on the vehicle 10 being an automobile, the vehicle may be any vehicle, such as a plane, train, boat, ATV, UTV, motorcycle, etc.

FIG. 2 illustrates a seat 12. The vehicle seat 12 includes a back rest portion 18 and a seating portion 20. The back rest portion 18 includes a frame and/or suspension 22 that supports a cushion 24. The seating portion 20 includes a frame and/or suspension 22 that supports a cushion 24. The frame and/or suspension 22 may be the same for both of the back rest portion 18 and seating portion 20, or the frame and/or suspension 22 may be different components. Similarly, the cushion 24 may be the same for both the backrest portion 18 and seating portion 20 or the cushion 24 may be different, individual components.

The vehicle seat 12 may include one or more air distribution devices 100. An air distribution device 100 may be located in the backrest portion 18. An air distribution device 100 may be located in the seating portion 20. The air distribution device 100 may be installed or fastened to the frame suspension 22 and/or to the cushion 24 of the backrest portion 18 and/or seating portion 20 of the vehicle seat 12. The air distribution device 100 may be located at the A-side of the cushion 24, at the opposing B-side of the cushion 24, or within the thickness of the cushion 24, between the A-side and the B-side. A cover, trim layer, padding, or other layer 25 may be provided in front of and/or behind the air distribution device 100.

FIGS. 3 and 4 illustrate an air distribution device 100. The air distribution device 100 comprises a housing 102. The housing 102 may include a first or top cover or layer 104, an opposing second or bottom cover or layer 106, and an interior space 107 defined therebetween.

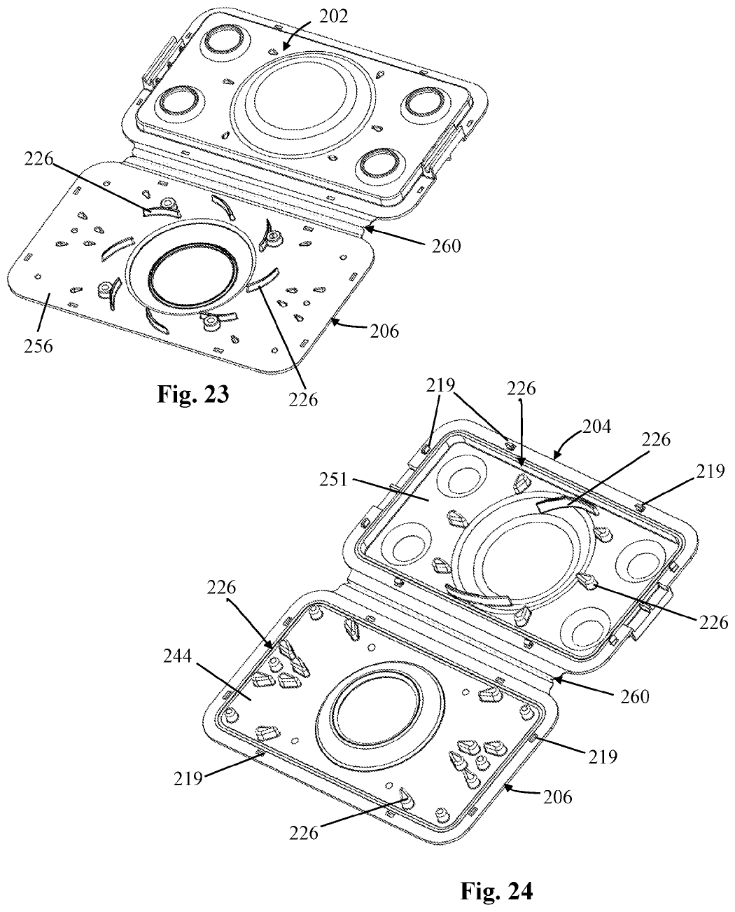

The top and/or bottom cover or layer 104, 106 may be made of a generally rigid material. The top and/or bottom cover 104, 106 may be made of a generally flexible material. The top and/or bottom cover 104, 106 may be made of a plastic, metal, composite, biodegradable material, or printed material. For example, the top and/or bottom cover or layer may be made of polypropylene, nylon, polyethylene, polystyrene, acrylic, polyvinyl chloride, polyethylene terephthalate, low-density polyethylene, HDPE, aluminum, steel, or a combination thereof. The top and/or bottom cover may be formed via a plastic injection molding process, a stamping process, a printing process, a 3D printing process, the like, or a combination thereof. In some configurations, the top and/or the bottom cover 104, 106 may be made of a fabric material. The fabric material may be taped, welded, or otherwise connected to the other. For example, the bottom cover 106 may be made of a fabric material and then taped or welded to the top cover 104, which may be made of a rigid material, or vice versa. In some configurations, the top or the bottom cover or layer may be eliminated. This means that the housing would be comprised of only the top or bottom layer and the omitted layer may be derived from another adjacent structure or feature, such as the cushion or trim or suspension of the vehicle seat. In some configurations the top or the bottom cover or layer may be integrated. This means that the top and bottom cover or layer are a single integral element. For example, the housing may be formed from a single cover or layer that is then folded which then leads to a top and bottom cover or layer being formed by virtue of its orientation (See FIGS. 23 and 24 for example). Any of the aforementioned descriptions and/or following description can be applied to any of the housings or air distribution devices disclosed herein.

The top and bottom covers or layers 104, 106 may be joined together with one or more fasteners. The one or more fasteners may extend into and/or through one or both of the covers or layers 104, 106. Additionally, or alternatively, the covers or layers 104, 106 may be joined together at their peripheries or edges 109 via one or more fasteners. For example, the edges or peripheries may be joined together by way of welding, RF welding, tape, double sided tape, adhesive, laminating, a pressure sensitive adhesive, one or more mechanical fasteners, or a combination thereof. Virtually any fastener may be used to connect and/or maintain the two housings together.

The air distribution device 100 may include an air moving device 108. The air moving device 108 may be a fan, a centrifugal fan, a 360-degree fan, and/or a radial fan. The air moving device may also be referred to as a blower, a blowing device, a suction device, a ventilator, or any other device for generating an air flow.

The air moving device 108 may include one or more impellers 110. The impeller 110 may include one or more blades or fins that are configured to rotate about a central axis A of the air distribution device 100 or blower 108 or impeller 110.

As will be discussed further below, the air distribution device 100, the air moving device 108, and/or the impeller 110 may operate in a push mode, where the impeller 110 rotates about the axis A and draws air into the housing 102 through one of the covers (i.e., the bottom cover 106) and then expels the drawn-in air through the other cover (i.e., the top cover 104) or vice versa. In some configurations, the impeller 110 may operate in a pull mode, where the impeller 110 rotates about the axis A and draws air into the housing 102 through one of the covers (i.e., the top cover 104) and then expels drawn-in air through the other cover (i.e., bottom cover 106) or out of a region between the top and bottom cover.

The air distribution device 100 and/or the air moving device 108 may include a connector 112. The connector 112 may electrically connect the air distribution device 100 and/or air moving device 108 to a controller 114. The controller 114 may be or may be part of a computer or processor associated with the vehicle seat, the air conditioning system, the vehicle, or a combination thereof. The controller 114 may function to turn the air distribution device 100 and/or air moving device 108 ON and/or OFF and/or to regulate a speed and/or temperature of air expelled from the air moving device 100 and/or a duration and/or frequency that the air moving device 108 operates.

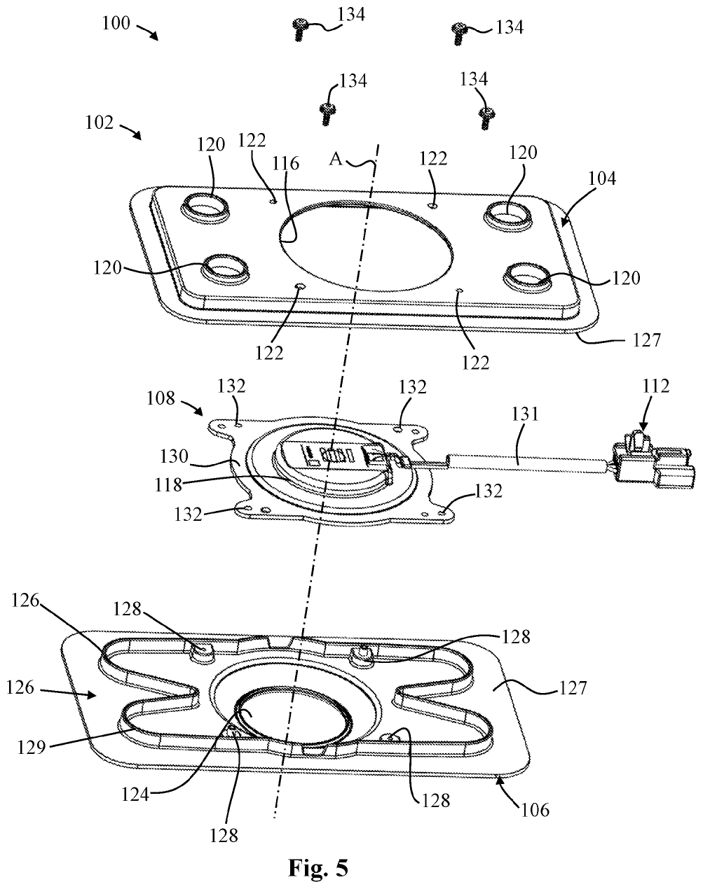

FIG. 5 illustrates an air distribution device 100. The first or top cover 104 may have a generally planar substrate that comprises an opening 116 through which a portion 118 of the air moving device 108 is configured to extend (See FIG. 3). The opening 116 may be centered between the top and bottom edges of the cover 104 and/or the lateral side edges of the cover 104. In other configurations, the opening 116 may be offset towards one or more of the edges of the cover 104.

In some configurations, this opening 116 may be eliminated and the portion 118 of the air moving device 108 may be covered or encapsulated by the top cover. In some configurations, the portion 118 of the air moving device 108 may be integrated with the top cover 104. This may mean that the air moving device 108 or the housing 130 of the air moving device includes the top cover 104. The portion 118 may include at least part of the impeller, the electronics of the connector 112, a cover, cap or layer covering the impeller, or a combination thereof.

The first or top cover 104 may include one or more ports or apertures 120. An air flow generated by the air moving device 108 can be expelled from the housing 102 through the one or more ports or apertures 120. In some configurations, when the air distribution device 100 is operating in a reverse or pull mode, an air flow may be directed into the housing 102 via the one or more ports 120 and then collected in the open space 107 of the housing 102 before being exhausted from the housing 102. The top cover 104 may include one or more mounting bores 122. The one or more ports or apertures 120 may be equally distributed on the cover 104 (i.e., symmetrically about the various axes of the cover 104 and/or housing 102. The one or more ports or apertures 120 may be unequally distributed on the cover 104 (i.e., not-symmetrically about the various axes of the cover 104 and/or housing 102. This means that the one or more ports or apertures 120 may be provided virtually any location, spacing, pattern, or orientation depending on desired air flow and dynamics. Moreover, the size of the one or more ports 120 may be the same for all ports 120 or the sizes may be different. Again, this may be dependent on a desired air flow in certain regions and dynamics. The ports 120 may be circular in shape or may be any other shape, such as oval, oblong, square, rectangles, slots, etc. The ports 120 may include one or more grills or screens over them to direct the air flow and/or to prevent dust or debris from entering the housing 102, 107. This understanding relating to the sizes, shapes, and position of the ports applies to all examples of the air distribution device disclosed herein.

The bottom cover 106 may have a generally planar substrate that comprises an opening 124 through which air may be drawn into the housing 102 via the rotating impeller of the air moving device 108. In some configurations, the air moving device 108 (FIG. 5) may be integrated with the bottom cover 106. This may mean that the air moving device 108 or housing 130 includes the bottom cover 106 for the bottom covers attach directly to the air moving device 108. Again, the shape, size, location of the opening 124 may vary just like was disclosed above with respect to the opening 116.

The second or bottom cover 106 and/or the top cover 104 may comprise an air guiding structure or a rib structure 126 surrounding the opening 124. The air guiding or rib structure 126 may be inside 107 the housing 102. The air guiding or rib structure 126 may be configured to direct an air flow in a direction of the one or more ports 120. This may help increase efficiency of the air distribution device by ensuring that air generated by the air moving device 108 is guided to one or more ports 120 so that the air flow can be expelled towards an occupant of the vehicle seat. In some configurations, the air guiding structure or rib may also create a seal between the top and bottom covers 104, 106 so that the generated air flow does not leak or escape between the two covers or layers 104, 106. In this regard, after the housing 102 is assembled, the air guiding or rib structure, maybe at least partially collapse or compressed between the two generally planar structures of the covers 104, 106. The bottom cover 106 may include one or more mounting bores 128 or bosses. The air guiding or rib structure may be made of a plastic material. The air guiding or rib structure may be made of rubber or sealing member or foam. The air guiding or rib structure may be made of a rigid or flexible or compressible material. The air guiding or rib structure may be made of the same material or different material as the top and/or bottom housing.

The air moving device 108 comprises a housing or bracket 130. The air moving device 108 may include one or more mounting bores or mounting flanges 132.

To assemble the air distribution device 100, one or more fasteners 134 may be directed into and/or through the mounting bores or bosses 122, 132, and 128 in the top cover 104, the air moving device 108, and the bottom cover 106. The opposing generally planar regions or flanges 127 of the top and bottom covers 104, 106 may be brought into contact with one. In some configurations one or more fasteners (i.e., adhesive, sealant, seal, etc.) may be provided between the general planar regions 127. This may help ensure the structural integrity of the housing after it is assembled. This may also help ensure that an air flow directed into the housing does not leak or escape between the two covers 104, 106 and is instead exhausted out of the one or more ports or apertures 120.

When the two covers 104, 106 are brought together, a top surface 129 of the air guiding or rib structure 126 make contact an inside surface of the top cover 104. In some configurations, the air guiding or rib structure 126 may be compressed between the two covers 104, 106. In some configurations, a slight gap or spacing may be defined between the top surface 129 of the air guiding or rib structure 126 and the inside surface of the top cover 104.

In some configurations, the air guiding or rib structure 126 may also, or may instead, be provided on the inside surface of the top cover 104. In such a configuration, the air guiding or rib structure 126 may function in a similar manner as described above with the air guiding or rib structure 126 provided on the bottom cover 106.

After the device 100 is assembled, one or more cables or wires 131 connecting the air distribution device 108 to the connector 112 may be routed between the two cover halves 104, 106. In this regard, an opening or recessed region may be provided at or in one or both of the cover halves 104, 106 to allow the one more cables or wires 131 to pass between the cover halves 104, 106. Preferably, the opening or recess region is such that the one or more cables or wires 131 can pass between the two parts 104, 106 without allowing a significant amount of air flow to escape there between. In other configurations, the one or more cables or wires 131 may extend out of the opening 116, as can be seen in FIG. 3 or through one or more of the ports or apertures 120, which may be used for only passing the cable or wire 131 or may be also used for directing air into and/or out of the housing 102.

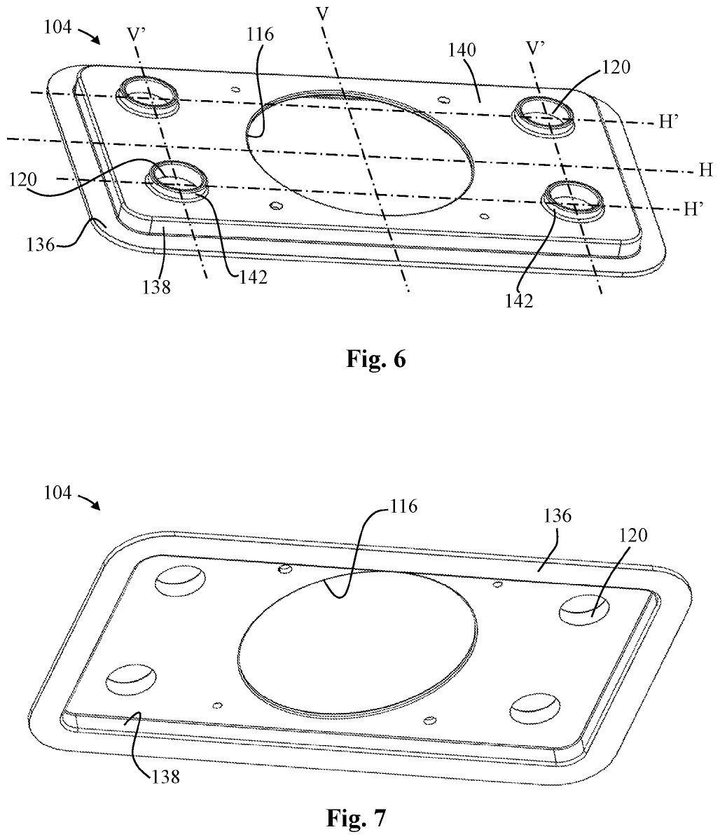

FIGS. 6 and 7 illustrate the first or top cover 104. The top cover 104 may have a generally planar and/or rectangular shape. However, in other configurations, the top cover 104 may have another shape, such as a square, round, oval, diamond, or any other polygon shape. In other configurations, the shape can have any number of curved sides. The top cover 104 may have a concave or convex shape or structure, which may be dependent on the air flow generated and/or the environment into which the air distribution device is intended to be installed.

The first or top cover 104 may include a flange 136. The flange 136 may surround a perimeter of the cover 104. A generally vertical or upright wall 138 may be defined between the flange 136 and the top surface 140. The top surface 140 including the opening 116 and the one or more ports 120. The wall 138 may be generally vertical, relative to the flange 136 and/or top surface 140; however, in some configurations, the wall 138 may be arranged at a non-vertical angle relative to the flange 136 and/or top surface 140. In some configurations, the wall 138 may include one or more ports 120. In some configurations, the wall 138 may be eliminated and the flange 136 and top surface 140 may be arranged in the same plane. In some configurations the flange 136 may be eliminated.

The wall 138 may have a height that generally corresponds to a height of the air guiding or rib structure 126 illustrated and discussed above in the previous figures. This may allow for the air guiding or rib structure 126 to not be compressed or only slightly compressed when the two cover halves are joined together.

The opening 116 in the top cover 104 may be generally circular as shown. In other configurations, the opening 116 can have another shape, such as a square, oval, diamond, or any other polygon shape. In other configurations, the opening 116 can have any number of curved sides.

The opening 116 may be centered along a horizontal axis H and/or vertical axis V. In other configurations, the opening 116 may be offset from one or both axis H, V. The opening 116 may be centered about the center axis A (FIG. 5). Or in some configurations, the opening 116 may be offset from the center axis A. The opening 116 may provide for at least a portion of the air moving device 108 to extend through after assembly of the device 100. In other configurations, opening 116 may serve as a similar purpose to the ports 120.

The first or top cover 104 may have one or more ports 120. An air flow generated by the air moving device 108 may be expelled from the housing 102 through the one or more ports 120. The one or more ports 120 in the top cover 104 may be generally circular as shown. In other configurations, the one or more ports 120 can have another shape, such as a square, oval, diamond, or any other polygon shape. In other configurations, the one or more ports 120 can have any number of curved sides. In other configuration, air may be suctioned into the housing through the one or more ports 107.

The one or more ports 120 may be aligned with one or more ducts or vents 26, 28 defined in the seat cushion 24 (FIG. 11). The one or more ports 120 may be aligned along an axis H′ that is offset from and generally parallel to the horizontal axis H. The one or more ports 120 may be aligned along an axis V′ that is offset from and generally parallel to vertical axis V. In other configurations, the one or more ports 120 may be randomly spaced on the top cover 104. In some configurations, the ports 120 may be arranged radially around the opening 116. In some configurations, the center opening 116 may be a port 120. The one or more ports 120 may have a common size and shape. In some configurations, the size and shape of the ports 120 may be different. For example, a larger sized port 120 may be preferred in some regions to allow a greater amount of air to flow therefrom. For example, a smaller sized port 120 may be preferred in some regions to allow a lower amount of air to flow therefrom.

An upright or standing flange or duct 142 may surround one or more of the ports 120. The flange or duct 142 may elevate or elongate the port 120 above the top surface 140 of the top cover 104. The flange 142 may be used to connect the air distribution device 100 to a cushion 24 or seat pad (FIG. 11). That is, the flange 142 may be received into a port or duct or opening defined in the cushion 24. In some configurations, one or more of the flanges 142 may be eliminated. The flange 142 may have the same shape as the port 120 or a different shape. The flange 142 may be configured to lock the cover 104 and/or device 100 to the cushion 24. In this regard, the size of the flange 142 may be slightly larger than the mating duct or port in the cushion 24 to provide an interference fit to ensure the device 100 is maintained or connected to the cushion 24.

The layout of the mounting bores 122 in the top cover 104 may be generally aligned with one another along the horizontal and/or vertical axis. In some configurations, the mounting bores 122 may be arranged offset or staggered from one another relative to one or more of the axis.

The features or geometry of the first or top cover 104 may be generally symmetrical about or relative to the horizontal axis H and/or the vertical axis V. In some configurations, the features or geometry of the top cover 104 may be asymmetric about or relative to the horizontal and/or vertical axis V.

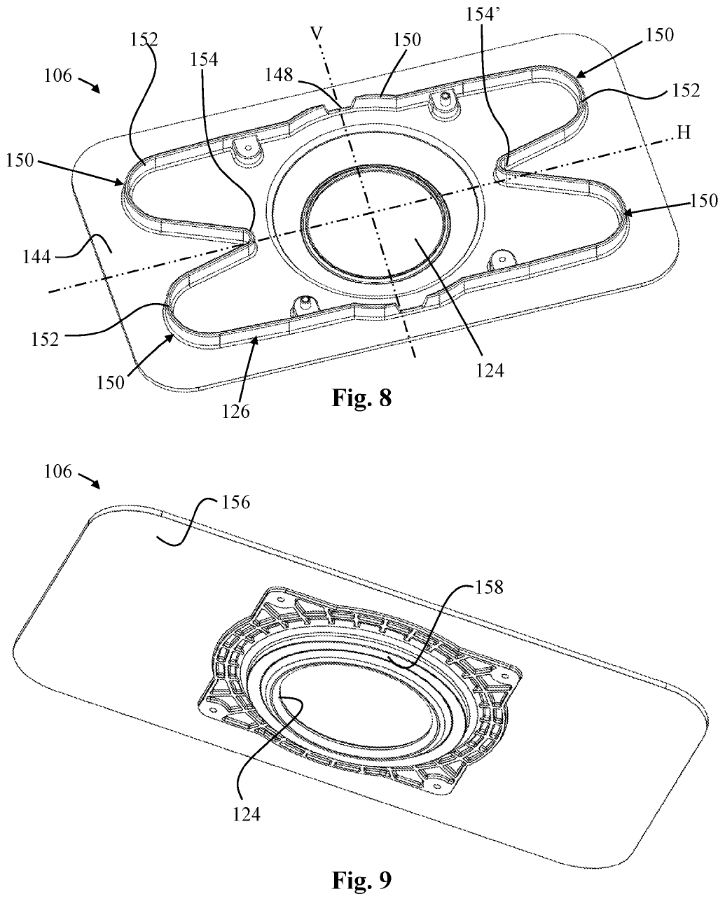

FIGS. 8 and 9 illustrate the second or bottom cover 106. The bottom cover 106 may have a generally planar and rectangular shape. However, in other configurations, the bottom cover 106 may have another shape, such as a square, round, oval, diamond, or any other polygon shape. In other configurations, the shape can have any number of curved sides. The bottom cover 106 may have a size, shape, geometry and/or configuration that is the same as the first or top cover 104.

The opening 124 in the bottom cover 106 may be centered along a horizontal axis H and/or vertical axis V of the bottom cover 106. In other configurations, the opening 124 may be offset from one or both axis H, V. The opening 124 may be centered about the center axis A (FIG. 5). Or in some configurations, the opening 124 may be offset from the center axis A. The opening 124 in the bottom cover may be aligned along the axis A with the opening 116 in the top cover. In some configurations, the openings 124, 116 may be offset from one another about the axis A. The bottom cover 106 may have one or more than one opening 124. The opening 124 may be the same size and/or shape as the opening 116 in the first cover 104. The openings 124, 116 may be generally aligned along axis A or may be offset from one another.

The bottom cover 106 may include an inside surface 144. The inside surface 144 may face an inside surface or the first or top cover 104. The inside surface 144 may face an inside of the housing 102. The inside surface 144 may include an air guiding or rib structure 126. The rib structure may surround the opening 124. The rib structure 126 may surround the one or more ports 120 in the top cover 104. The rib structure 126 may have a structure that functions to direct or guide an air flow from the air moving device 108 to the one or more ports 120. The rib structure 126 may be arranged to guide or direct generally the same amount of air to the ports 120. The rib structure 126 may be arranged to guide or direct more air to some of the ports 120 and less air to other ports 120. The rib structure 126 may be a continuous structure. Continuous structure means that there are no breaks or voids in the rib structure. In some configurations, the rib structure 126 may have one or more breaks or termination regions where no rib structure is located. In some configurations, a height of the entire rib structure 126 may be generally consistent. In some configurations, a height of the entire rib structure 126 may vary. For example, there may be one or more regions 148 where a height of the rib structure is lower than other regions 150, which may include a rib or other raised structure. For example, there may be one or more regions where the rib structure ends and begins in another region.

The rib structure 126 may include one or more petals 152. A petal 152 may be a region of geometry of the rib structure 126 that surrounds a port 120 in the top cover 104 after the covers 104, 106 are connected together. A petal 152 may have a rounded shape; however, the shape may be virtually any shape. Preferably, the shape is such that the air is guided or directed to the port 120.

The rib structure 126 may include a vertex 154. A vertex 154 may be a region of the rib structure 126 where two or more petals 152 are joined together. The vertex 154 may be generally aligned along the horizontal axis H. Alternatively, the vertex 154′ may be generally offset from the horizontal axis H. Placement or arrangement of the vertex 154 may be specified to direct the proper around of air flow to the one or more ports 120.

In some configurations, the rib structure 126 may additionally, or instead, be located on the top cover 104, for example, on the inside surface shown in FIG. 7.

The features or geometry of the bottom cover 106 may be generally symmetrical about the horizontal axis H and/or the vertical axis V. In some configurations, the features or geometry of the bottom cover 106 may be asymmetric about the horizontal and/or vertical axis V.

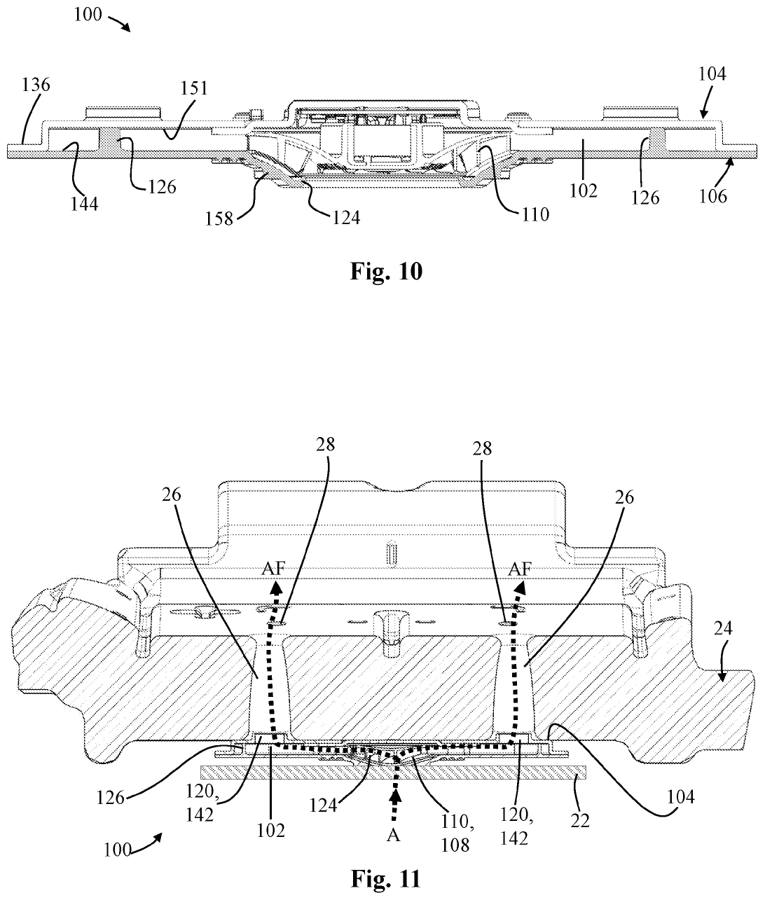

An outside surface 156 of the bottom cover 106, which opposes the inside surface 144, may include a flange 158. The flange 158 may surround the opening 124. The flange 158 may provide room to house the impeller 110 of the air moving device 108 (See FIG. 10). However, the air moving device 108 and/or the impeller 110 may be configured to fit within the housing 102 such that no flange 158 is required. In some configurations, the flange 158 may be part of the housing 130 of the air moving device 108. The flange 158 may be integrally formed with the bottom cover 106. And other configurations, the flange 158 may be attached to the cover via one or more fasteners.

Referring now to FIG. 10, after the housing 102 is assembled or connected together form the first and second covers 104, 106, the flange 136 of the top cover 104 is in contact with the inside surface 144 of the bottom cover 106. The air distribution device 100 may include a fastener or seal in the region where the flange 136 connects to the bottom cover 106. The fastener or seal may reduce, minimize, or eliminate air flow from leaking between the two cover halves 104, 106 and/or to prevent separation of the two halves 104, 106.

The rib structure 126 may have a height that extends from the inside surface 144 of the bottom cover 106 to the inside surface 152 of the top cover 104. The rib structure 124 may contact the inside surface 151 of the top cover 104. In some configurations, the rib structure 126 may be shorter than the inside surface 151 of the top cover 104 such that the top of the rib structure 126 does not contact the inside surface 151 of the top cover 104. In some configurations, the rib structure 126 may contact the inside surface 151 of the top cover 104 and in other regions may be free from contacting the inside surface 151 of the top cover 104. The rib structure 126 may function to direct the air flow inside of the housing 102 between the impeller and the ports 120. The rib structure 126 may function to restrict or prevent the housing 102 from collapsing or being crushed under the weight of a passenger or object in the vehicle seat. The rib structure 126 may function to maintain the spacing of the interior region of the housing 102.

The air distribution device 100 may include a fastener or seal in the region where the rib structure 126 contacts the inside surface 151 of the top cover 104 to reduce or minimize air flow from leaking to undesired locations. The fastener may include a weld, RF weld, an adhesive tape, a sealing tape, or the like. The fastener or seal may be located in a region between the inner surfaces of the covers 104, 106. The fastener or seal may be located in a peripheral region of the covers 104, 106.

The rib structure 126 may restrict or prevent the housing 102 from collapsing, for example under the weight of an occupant or load in the vehicle seat.

The housing 102 or interior space 107 may be free of any layers or structure between the two halves 104, 106. The housing 102 or interior space 107 may be free of any layers or structure between the two halves 104, 106, other than the rib structure 126, the impeller, and/or the housing of the air moving device 108.

FIG. 11 illustrates an air distribution device 100 installed in a vehicle seat. The air distribution device 100 may be attached to the cushion 24 and/or to a frame or suspension 22 of the vehicle seat. The air distribution device 100 may be received into a recess or depression formed in the bottom or B-side of the cushion 24 or maybe attached or supported at the B-side of the cushion 24. The cushion may be part of the backrest portion and or the seating portion, as discussed above at FIG. 2. The air distribution device 100 may be attached to the cushion and/or to the frame or suspension 22 via one or more fasteners, like one or more pins, push-pins, screws, tape, double sided tape, an adhesive, clips, or a combination thereof. In other configurations, the air distribution device 100 may be located at the opposing A-side of the cushion, below a padding layer and or a trim or cover layer. In such a configuration, an air flow would not need to pass through a thickness of the cushion 24.

During use, a computer or processor of the vehicle seat and/or vehicle may turn the air moving device ON and rotate the impeller. This may be in response to a user or operator calling for the associated comfort system to be activated. Air A may be drawn into the housing 102 via one or more openings 124 in the bottom cover 106 via the rotating impeller 110 of the air moving device 108. The air A is then guided by the rib structure 126 to the one or more ports 120 in the top cover 104. The flange 142 surrounding the port 120 may be received into a duct 26 extending though a thickness of the cushion 24. The air flow AF may exit the housing 102 via the one or more ports 120 and may be directed into the corresponding ducts 26. The air flow AF may then flow through an opening 28 defined in the cushion 24 towards an occupant in the vehicle seat. This may be referred to as a push configuration or operation of the air moving device and/or air distributing device. The expelled air may be ambient. In other configurations, the expelled air may be conditioned, meaning it is warmer or colder than ambient. The conditioned air may be heated or cooled by passing air past a suitable air condaitioner (i.e., heating or cooling device).

In some configurations, the air distribution device 100 and/or air moving device 108 may operate in a reverse mode or pull mode or configuration. In such a configuration, air may be drawn into the housing 102 through the one or more ports 120, collected in the open space 108, and then exhausted from the housing 102 via the one or more openings 124 in the bottom cover 106.

It is understood that any feature, structure, element, or portion of the air distribution device disclosed herein may be duplicated, eliminated, separated, added, rearranged. Moreover, any feature, structure, element, or portion of the air distribution device 100 may be added to the air distribution device 200 and vice versa.

FIGS. 12 and 13 illustrate an air distribution device 100. The air distribution device of FIGS. 12 and 13 may be substantially similar to the illustrated and described air distribution device 100 described above and/or at FIGS. 3 and 4. Therefore, unless otherwise noted, the description relating to FIGS. 3 and 4 may apply to the air distribution device 100 of FIGS. 12 and 13 (and/or any other distribution device disclosed herein) and vice versa. The air distribution device 100 comprises a housing 102. The housing 102 may include a first top cover or layer 104, an opposing second bottom cover or layer 106, and an interior space 107 defined therebetween.

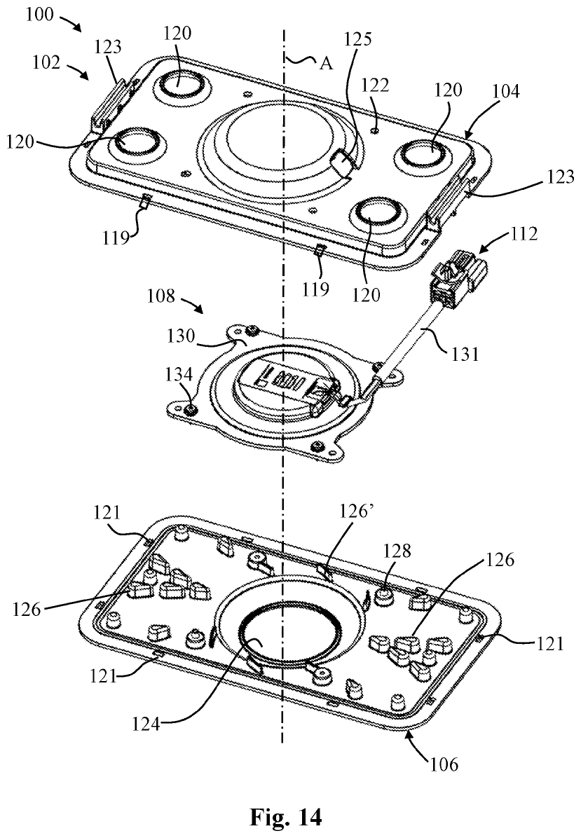

The top and bottom covers or layers 104, 106 may be joined together with one or more fasteners. The one or more fasteners may be or may include one or more of any of the fasteners disclosed herein. As perhaps better illustrated at FIG. 14, the one or more fasteners may include one or more prongs, tabs, or protuberances 119 that are configured to engage one or more corresponding apertures or notches 121 in the opposing cover. For example, the top cover 104 may include one or more prongs, tabs, or protuberances 119 and the bottom cover 106 may include one or more apertures or notched 121 for the prongs, tabs, or protuberances 119 to engage or snap into. Of course, the one or more prongs, tabs, or protuberances 119 may instead, or may also, be included on the bottom cover 106 and the one or more corresponding apertures 121 may instead, or may also, be included on the top cover 104. This may be in addition or instead of using screws or other fastening techniques. Using protuberances 119 vs screws may advantageously reduce cost, assembly time, weight, or a combination thereof.

The first or top cover 104 may include one or more attachment features 123. In attachment feature 123 may be structure that is configured to attach the housing 100 to the vehicle seat and/or to one or more components of the vehicle seat. For example, the one or more attachment features 123 may be a clip or clamp configured to engage or connect the distribution device 100 to the seat cushion, the seat frame, a seat suspension, or a combination thereof. In the example illustrated at FIG. 14, the attachment feature 123 is a channel, slot, clamp, or groove, that is configured to engage a wire or other structure of the seat frame or suspension. In other configurations, the one or more attachment features 123 may be a pin, a fastener, an adhesive, a double sided tape, a hook and loop fastener, a pressure sensitive tape or adhesive, or a combination thereof. The first or top cover 104 may include an opening or aperture 125 through which the cable or wire 132 can pass or extend through.

The air distribution device 100 may include an air moving device 108. The air distribution device 100 and/or the air moving device 108 may include a connector 112. The connector 112 may electrically connect the air distribution device 100 and/or air moving device 108 to a controller. The controller may be or may be part of a computer or processor associated with the vehicle seat, the air conditioning system, the vehicle, or a combination thereof. The controller may function to turn the air distribution device 100 and/or air moving device 108 ON and/or OFF and/or to regulate a speed and/or temperature of air expelled from the air moving device 100 and/or a duration and/or frequency that the air moving device 108 operates.

The second or bottom cover 106 may include one or more air guiding structures or a rib structures 126. The one or more air guiding structures or rib structures 126 may also be referred to as one or more baffles. The one or more air guiding structures, rib structures, or baffles 126 may have similar structure and/or function of the baffles illustrated and described in Applicant's commonly owned PCT Publication WO 2019/112823A1 (PCT/US2018/062425 filed Nov. 26, 2018), which is incorporated by reference in its entirety for all purposes. For example, the one or more air guiding structures or rib structures or baffles 126 may have a size, structure, shape, orientation, and/or position like the baffles 62 illustrated at FIGS. 11B, 11C, 12B, 12C at element 62 of the aforementioned PCT Publication WO 2019/112823A1.

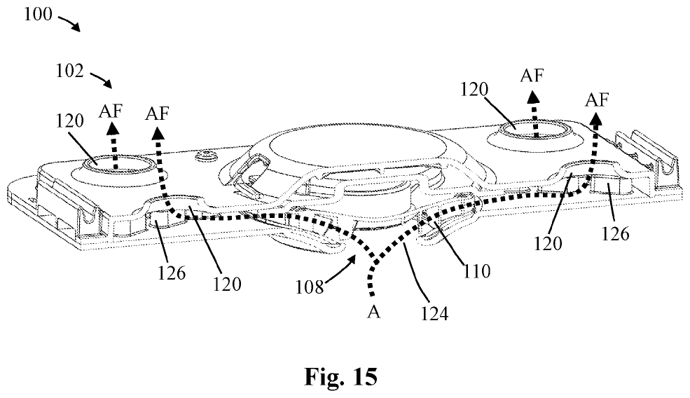

The one or more air guiding structures or rib structures 126 may have a similar purpose and or function as those illustrated and described above in the previous figures including to guide or direct the air flow to the one or more ports 120. In contrast to the continuous air guiding structure or a rib structure 126 in FIG. 6, the one or more air guiding structures or a rib structures 126 in FIGS. 14 and 15 are discontinuous. Discontinuous means there is a space or gap between adjacently located rib structures 126 or baffles. The one or more air guiding structures or a rib structures 126 may include virtually any shape. For example, the one or more air guiding or a rib structures 126 may have a teardrop or arrow shape where one end of the structure 126 is smaller or more narrow than an opposing end of the structure 126. Other air guiding or a rib structures 126 or baffles may have a curved or arc shape, such as those at reference number 126′. The baffles 126′ may be curved in the direction of rotation of the impeller or in an anti-direction of the direction of rotation of the impeller.

FIG. 15 illustrates operation of the air distribution device 100. During use, a computer or processor of the vehicle seat and/or vehicle may turn the air moving device ON and rotate the impeller 110. Air A may be drawn into the housing 102 via one or more openings 124 in the bottom cover 106 via the rotating impeller 110 of the air moving device 108. The air A is then guided by the rib structure or baffles 126 to the one or more ports 120 in the top cover 104. The air flow AF may exit the housing 102 via the one or more ports 120 and may be directed into the one or more ducts or vents in the cushion (See FIG. 11 for example).

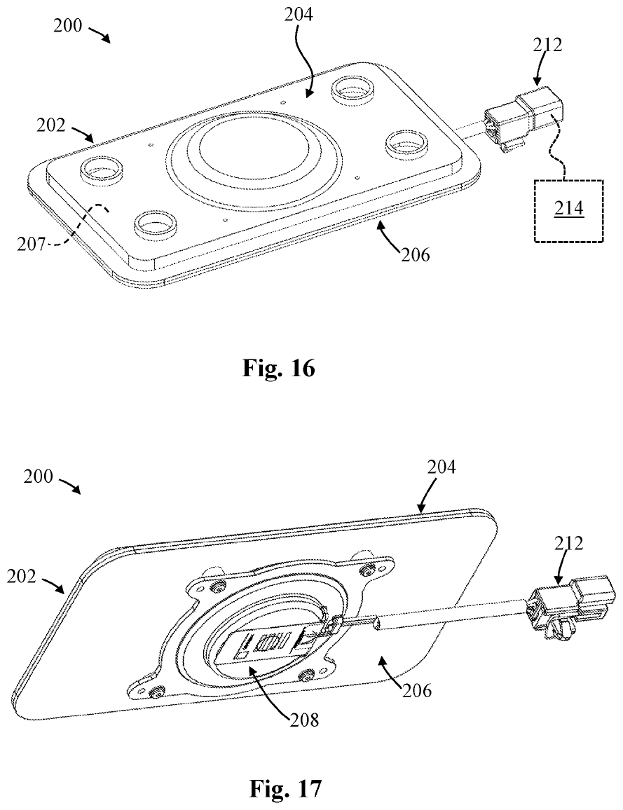

FIGS. 16 and 17 illustrate an air distribution device 200. The features of the air distribution device 200 may be similar to the features of the air distribution device 100 described above in the previous figures. Similar elements in structure and/or function of the air distribution device 200 compared to the air distribution device 100 are referred to with reference numbers increased by 100. Statements made with respect to the structure of the air distribution device 100 may apply to the air distribution device 200 and vice versa, unless otherwise noted.

The air distribution device 200 comprises a housing 202. The housing 202 may include a first or top cover 204 and an opposing second or bottom cover 206 and an interior space 207 defined therebetween.

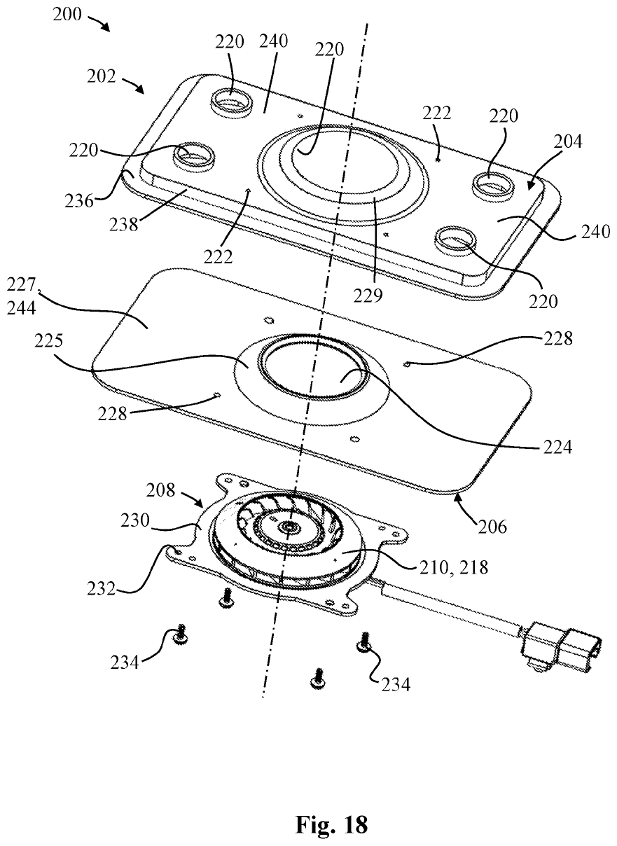

The air distribution device 200 may include an air moving device 208 comprising an impeller 210 (FIG. 18). The air distribution device 200 and/or the air moving device 208 may include a connector 212 for electrically connecting the air distribution device 200 and/or air moving device 208 to a controller 214. The controller 214 may be part of computer or processor associated with the vehicle seat, the air conditioning system, the vehicle, or a combination thereof.

FIG. 18 illustrates the air distribution device 200. The first or top cover 204 may have a generally planar substrate. The top cover 204 may include one or more ports 220 through which air can be pulled, sucked in, or drawn into the housing 202. The top cover 204 may include one or more mounting bores 222.

The second or opposing bottom cover 206 may have a generally planar substrate that comprises an opening 224 through which a portion 218 of the air moving device 208 and/or impeller 210 may extend. The opening 224 may be defined in a domed or raised region 225. The domed or raised region may be elevated relative to a planar surface 227 or inside surface 244 of the bottom cover 206. In some configurations, the air moving device 208 may be integrated with the bottom cover 206. This may mean that the air moving device 208 or housing 230 includes the bottom cover 206.

The domed region 225 in the bottom cover 206 may complement or oppose a corresponding domed or raised region 229 of the top cover 204.

To assemble the air distribution device 200, one or more fasteners 234 may be directed into and/or through the mounting bores 232, 228, 222 in the top cover 204, the air moving device 208, and the bottom cover 206. One or more adhesives, tapes, welds, RF welds, etc. may be used to secure or connect the perimeter of the top and bottom covers and/or to prevent air from leaking therebetween. In the assembled state, the domed portions 225,229 may be in contact or there may be a gap defined therebetween. In other configurations, one or more prongs or protuberances may be used to join the two halves 204, 206 together, like discussed above at FIG. 14.

In the assembled state, the impeller 210 may be arranged between the top and bottom covers 204, 206. In the assembled state, the impeller 210 may be arranged below the top cover. In the assembled state, the impeller 210 may be arranged below the bottom cover. In the assembled state, the impeller 210 may be located in the domed or raised region 225 and below the domed or raised region 229. In the assembled state, the impeller 210 may be located at least partially within both of the domed or raised regions 225, 229.

The top cover 204 may have a generally planar and/or rectangular shape. However, in other configurations, the top cover 204 may have another shape, such as a square, round, oval, diamond, or any other polygon shape. In other configurations, the shape can have any number of curved sides.

The top cover 204 may include a flange 236. The flange 236 may surround a perimeter of the cover 204. A wall 238 may be defined between the flange 236 and the top or outer surface 240. The top surface 240 includes the opening the one or more ports 220. The wall 238 may be generally vertical, relative to the flange 236 and/or top surface 240; however, in some configurations, the wall 238 may be arranged at a non-vertical angle relative to the flange 236 and/or top surface 240. In some configurations, the wall 238 may include one or more ports 220. In some configurations, the wall 238 may be eliminated and the flange 236 and top surface 240 may be arranged in the same plane.

The top cover 204 may have one or more ports 220. An air flow generated by the air moving device 208 may be drawn from the housing 202 through the one or more ports 220. The one or more ports 220 in the top cover 204 may be generally circular as shown. In other configurations, the one or more ports 220 can have another shape, such as a square, oval, diamond, or any other polygon shape. In other configurations, the one or more ports 220 can have any number of curved sides.

The one or more ports 220 may be aligned with one or more ducts or vents 26, 28 defined in the seat cushion 24 (FIG. 11).

The top cover 204 may include an inside surface 251. The inside surface 251 may face an inside surface 244 of the bottom cover 206. The inside surface 251 may face an inside 207 of the housing 202. The inside surface 251 may include a rib structure 226 or baffles. The rib structure 226 or baffles may surround the opening 216 in the top cover 204. The rib structure 226 may surround the one or more ports 220 in the top cover 204. The rib structure 226 may have a structure that functions to direct or guide an air flow from the one or more ports 220 in the top cover 204 to the air moving device 208. The rib structure 226 may have similar features and functions of the rib structure or baffles discussed above.

In some configurations, the rib structure 226 may additionally, or instead, be located on the bottom cover 204.

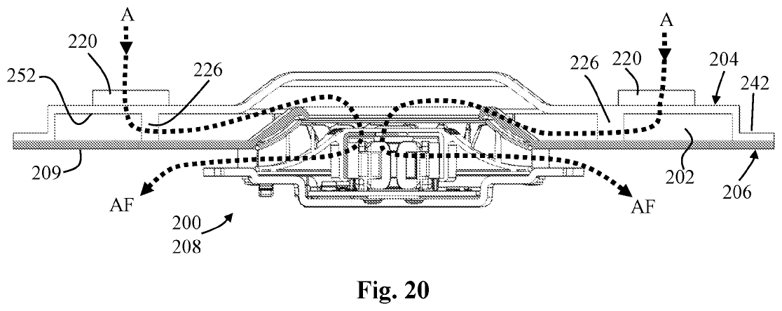

FIG. 20 illustrates the air distribution device 200 in use. Like the air distribution device 100, the air distribution device 200 may be attached to the cushion and/or to a frame or suspension of the vehicle seat. The air distribution device 200 may be received into a recess or depression formed in the bottom or B-side of the cushion. The air distribution device 200 may be attached to the cushion and/or to the frame or suspension via one or more fasteners, like pins, screws, tape, double sided tape, an adhesive, or a combination thereof. The air distribution device 200 may have any of the fastening mechanicals disclosed herein.

During use, a computer or processor of the vehicle seat and/or vehicle may turn the air moving device 208 ON. Air A may be drawn into the housing 202 from the vehicle seat or cushion via one or more ports 220 in the top cover 204 via the rotating impeller 210 of the air moving device 208. The air A is then guided by the rib structure 226 to the impeller 210 of the air moving device 208. The air flow AF may exit the housing 202 in a region between a bottom surface 209 of the bottom cover 206 and the housing of the air moving device 208. This may be referred to as a pull configuration or operation of the air moving device and/or air distributing device. As can be seen in FIG. 20, the air moving device 208 the blades of the impeller are partially located within or inside the housing 202 and partially located outside or below the bottom cover 106 of the housing 202.

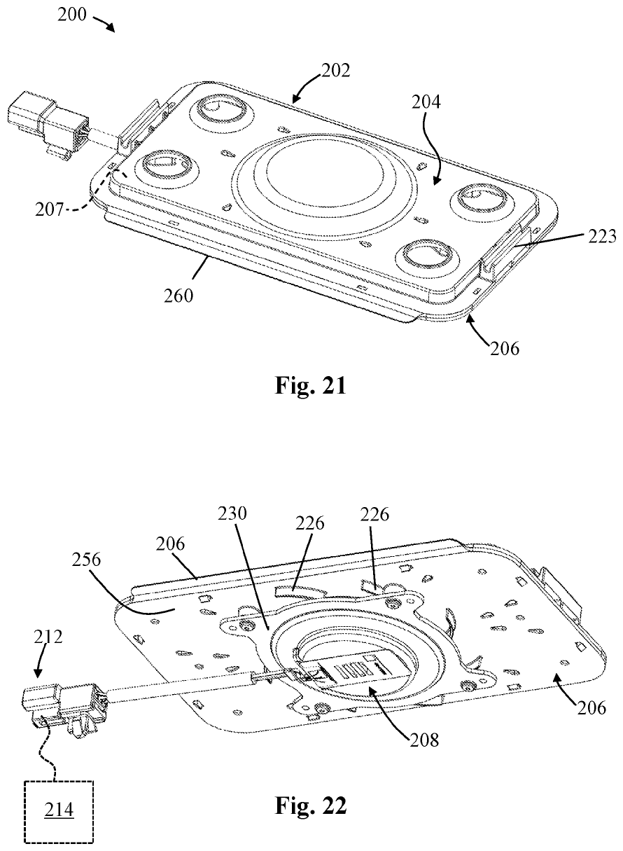

FIGS. 21 and 22 illustrate an air distribution device 200. The features of the air distribution device 200 may be similar to the features of the air distribution device 100, 200 described above in the previous figures. Similar elements in structure and/or function of the air distribution device 200 compared to the aforementioned air distribution devices are referred to with the same reference number or by a reference numbers increased by 100. Statements made with respect to the structure of the air distribution device 100 may apply to the air distribution device 200 and vice versa, unless otherwise noted. The air distribution device 200 comprises a housing 202. The housing 202 may include a first or top cover 204 and an opposing second or bottom cover 206 and an interior space 207 defined therebetween. As perhaps better illustrated in FIGS. 23 and 24 below, the top and bottom covers 204, 206 are joined together via a connector 260. The connector 260 may be a living hinge or material from the manufacturing process of the covers 204, 206. That is, the covers 204, 206 may be formed in an injection molding or stamping process and joined together via the connector 260. The two halves 204, 206 may then be folded about the connector 260 or hinge into the housing configuration illustrated in FIGS. 23 and 24. While the connector 260 is shown on the long ends of the covers 204, 206, the connector may instead be located on the short ends of the covers 204, 206 (i.e., on the side walls perpendicular to where the connector 260 is currently illustrated.

The air distribution device 200 may include an air moving device 208 comprising an impeller. The air distribution device 200 and/or the air moving device 208 may include a connector 212 for electrically connecting the air distribution device 200 and/or air moving device 208 to a controller 214. The controller 214 may be part of computer or processor associated with the vehicle seat, the air conditioning system, the vehicle, or a combination thereof.

The top and/or bottom covers 204, 206 may have the attachment feature 223 for connecting the housing 202 to the seat, cushion, or suspension structure thereof.

FIGS. 23 and 24 illustrate the housing 202 in its pre-assembled configuration. The housing 202 comprises the top and bottom covers or layers 204, 206 that are joined together with a connector or hinge 260. FIG. 23 illustrates the outside surfaces of the covers 204, that would be visible to a user after the covers 204, 206 are folded or pivoted about the connector or hinge 260. FIG. 24 illustrates the inside surfaces of the covers 204, that after folding the covers 204, 206 about the hinge or connector 206, would face one another and define the inside space 207 of the housing 202.

The top and bottom covers 204, 206 may comprise one or more prongs, protuberances and/or mating notches for joining or locking the halves together 204, 206 after folding the covers 204, 206 about the hinge or connector 260. One or more additional fasteners (adhesive, screws, welding, etc.) may also or may instead be used to join and secure the halves 204, 206 together. The inside surface 251 of the top cover 204 and/or the inside surface 244 of the bottom cover 206 may include one or more air guiding or rib structures 226 having the structure and/or function described herein. Also, or instead, the outer surface 256 of the bottom cover 206 may include one or more air guiding or rib structure for guiding or directing an air flow when air is pulled from within the housing and exhausted between the bottom or outside surface 256 of the second half 206 and the housing 230 of the air mover, as discussed above at FIG. 20 for example. The air guiding or rib structure 226 and its position relative to the housing 230 of the air moving device is also shown at FIG. 22.

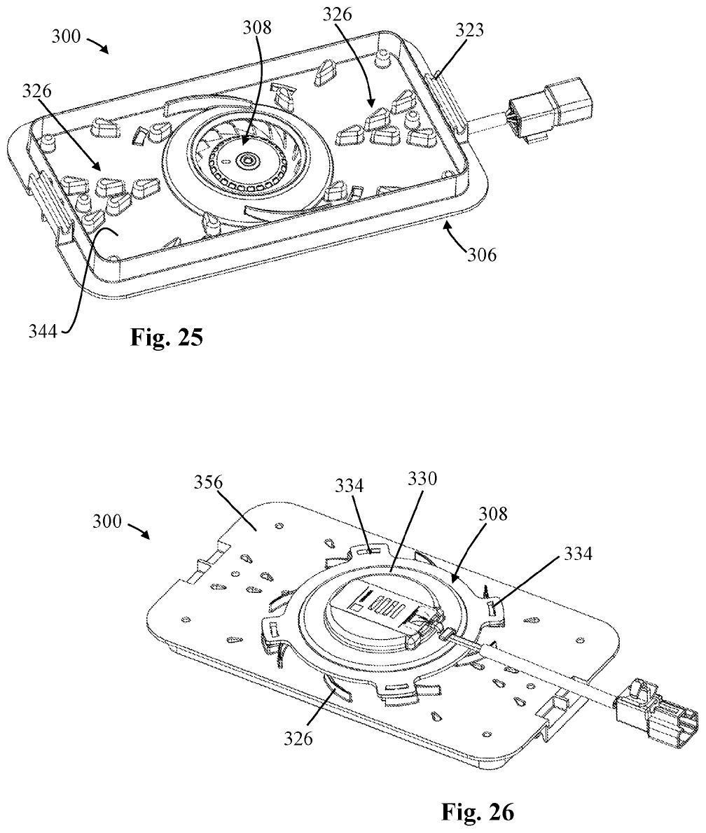

FIGS. 25 and 26 illustrate an air distribution device 300. The features of the air distribution device 300 may be similar to the features of any of the air distribution devices 100, 200 described above in the previous figures. Similar elements in structure and/or function of the air distribution device 300 compared to the air distribution device 100 and/or 200 are referred to with reference numbers increased by 200 or 100, respectively. Statements made with respect to the structure of the air distribution devices 200 and/or 100 may apply to the air distribution device 300 and vice versa, unless otherwise noted.

The air distribution device 300 may include only one cover or layer. For example, the air distribution device 300 may include the bottom cover 306 and omit the top cover (i.e., 106 and/or 206 in the previous figures). Alternatively, the air distribution device 300 may include the top cover and omit the bottom cover.

An inside surface 344 of the bottom cover 306 may include one or more air guiding or rib structures 326 for guiding or directing an air flow as described above. Also, or instead, the outer surface 356 of the bottom cover 306 may include one or more air guiding or rib structure 326 for guiding or directing an air flow when air is pulled from within the housing and exhausted between the bottom or outside surface 356 of the second half 306 and the housing 330 of the air mover, as discussed above at FIG. 20 for example.

The air moving device 308 may be attached to the outside surface 356 of the bottom cover 306 via one or more fasteners 334. In this embodiment, the one or more fasteners 334 may be one or more ribs or prongs or protuberances that engage corresponding notches or openings in the housing 330 of the air moving device 308.

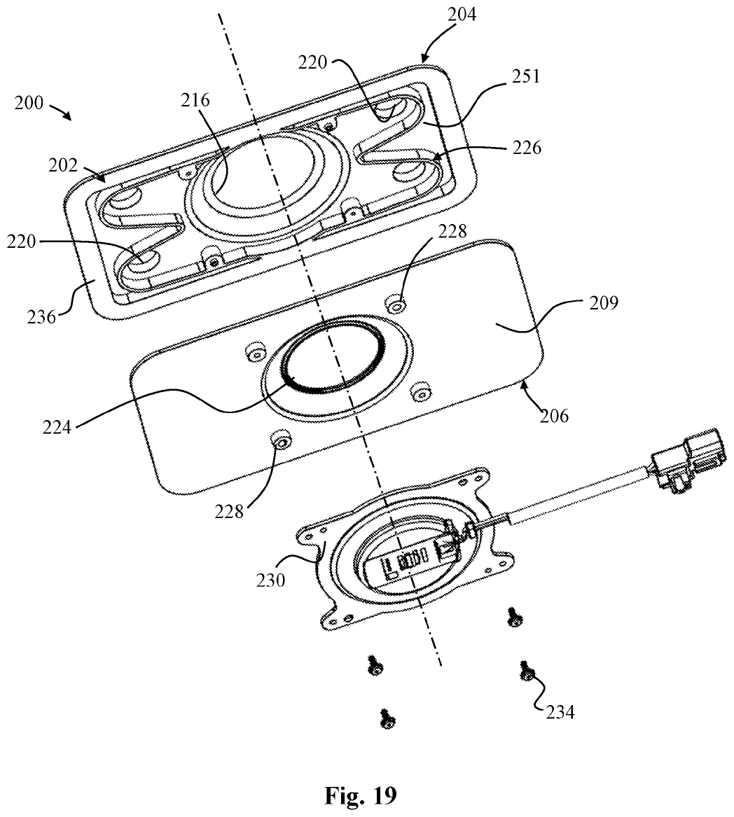

The air distribution device 300 may be installed in a vehicle seat so that the inside surface 326 of the bottom cover 306 faces a back side of the cushion or one or more layers of the vehicle seat. Accordingly, the back side of the cushion or one or more layers of the vehicle seat may form a top cover to the air distribution device 300. In this regard, the air moving device 308 may draw air into the interior of the device 300 (defined between the back side of the cushion and/or the trim layer of the vehicle seat) and then suction or draw air out of the interior of the device 300 through the opening in the bottom cover and between the housing 330 of the air mover, similar to what was illustrated and described above at FIGS. 16-24.

The air guiding structure, a rib structure, or baffle may function to distribute air within the open space of the housing, distribute air to the one or more ventilation ports, holes or apertures, provide a uniform distribution of air, a laminar distribution of airflow, a turbulent distribution of airflow, or a combination thereof. The one or more baffles may create a path between the one or more ventilation ports, holes, or apertures and the air mover so that air passes through each of the ventilation ports, holes, or apertures and not only the ventilation ports, holes, or apertures located closest to the air mover.

The one or more baffles may be a portion of the top cover, the bottom cover, or both that extend into the open space to create a fluid barrier. The one or more baffles may be added into an open space between layers before the housing is assembled or sealed. The one or more baffles may be curved, substantially straight, teardrop shaped, have a triangular or air plane wing shaped, crescent shaped, serpentine shaped, have a curved portion, have a straight portion, or a combination thereof. The baffles may be rounded on either end. The baffles may have a tear drop shape, with a body that decreases in width from one end to the other end. The baffles that are tear drop shaped may have sides that are substantially straight, concave, convex, curved, or any combination thereof. For example, the teardrop shaped baffle may have substantially straight sides with rounded ends. For example, the teardrop shaped baffle may have a middle body that is less in diameter than either end of the baffle. The one or more baffles may radiate outwards away from the opening where the blower or air mover is connected to the housing. The one or more baffles may be located proximate to a blower attachment feature (region where the air mover is connected to the housing) and assist in facilitating air between the blower and the one or more ventilation ports, holes, or apertures. For example, the baffles may assist the blower in moving equal amounts of air through a ventilation port, hole, or aperture that is located within 2 cm of the blower as the blower moves through a ventilation hole that is between 10 cm and 20 cm away. The one or more baffles may assist in directing air from a blower that is not centrally located to ventilation ports, holes, or apertures that are distal from the blower. For example, a blower may be located in a top quarter of a housing and the baffles may assist ventilation ports, holes, or apertures in a bottom quarter to distribute substantially a same volume of air as ventilation ports, holes, or apertures in the other three quarters of the plenum. For example, if the ventilation ports, holes, or apertures are not symmetrically spaced apart then the baffles will assist in distributing the air to more equally distribute the air to each of the ventilation ports, holes, or apertures (e.g., the volume distribution from ventilation hole to ventilation hole may have a difference of about 50 percent or less, about 40 percent or less, preferably about 30 percent or less, more preferably about 20 percent or less, and most preferably about 10 percent or less). The symmetry of the housing, location of the ventilation ports, holes, or apertures, location of the blower, or a combination thereof may be directly proportional to the number of baffles present in the housing. For example, if a blower is centrally located and the ventilation ports, holes, or apertures are symmetrically located along one or more two baffles may be needed. If the blower is not centrally located and the ventilation ports, holes, or apertures are asymmetrically located (relative to a 4-quadrant grid with a center being in a center of the housing) then 4 or 5 or more baffles may be needed. The one or more baffles may be shaped in a way to assist the flow of air from the blower to the one or more ventilation ports, holes, or apertures in an even fluid speed. The one or more baffles may have a shape to promote laminar flow. For example, the baffles may be generally straight, linear, free of curved portions, free of concave regions, free of sharp angles, or any combination thereof. A sharp angle may be where the baffle turns at an angle and the angle between two walls of the baffle form an angle of about 120 degrees or less, about 105 degrees or less, about 90 degrees or less, about 65 degrees or less, or about 50 degrees or less. The one or more baffles may be configured to prevent turbulent flow, preventing the open space from closing, or both. For example, the baffles may be straight, linear, free of curved portions, free of concave regions, free of sharp angles, or any combination thereof. A sharp angle may be where the baffle turns at an angle and the angle between two walls of the baffle form an angle of about 120 degrees or less, about 105 degrees or less, about 90 degrees or less, about 65 degrees or less, or about 50 degrees or less. For example, the baffles may increase in cross-sectional width as air moves away from the blower connection feature. For example, the baffles may increase in cross-sectional width as air moves towards to the blower connection feature. The baffles may have a height that is substantially the same height as a distance between a top layer and a bottom layer of the housing. The baffles may have a height that is less than a distance between the top layer and the bottom layer of the housing. The baffles may divide the housing so that more than one blower may be used. The baffles may divide a housing so that one region may be a push region and one region may be a pull region. The housing may also be referred to as a plenum.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### LISTING OF REFERENCE NUMERALS

10 vehicle
12 vehicle seat
14 front vehicle seat
16 rear vehicle seat
18 backrest portion
20 seating portion
22 frame/suspension of seat 12
24 cushion
25 trim or other layer of the of the seat 12
26, 28 ducts and vents in cushion 24
100 air distribution device
102 housing
104 first or top cover layer
106 second or bottom cover layer
107 open space of the housing between the first and second layers 104, 106
108 air moving device
110 impeller of the air moving device 108
112 connector
114 controller
116 opening in the first or top cover 104
118 portion of the air moving device 108
119 prongs, tabs protuberances joining the covers 104, 106 together
120 ports or apertures in the first or top cover 104
122 mounting bore or boss
123 attachment feature
124 opening in the second or bottom cover 106
125 opening for cable 131 to pass
126 air guiding or rib structure
127 opposing planar regions or flanges of the covers 104, 107
128 mounting bores or boss
130 housing of the air moving device
131 cable or wire
132 mounting bores or flange
134 fastener
136 flange of cover 104
140 top surface of cover 104
142 flange or duct of the port 120
144 inside surface of second cover 106
151 inside surface of top cover 104
152 petal
156 outside surface of the bottom cover 106
158 flange
200 air distribution device
202 housing
204 first or top cover
206 second or bottom cover
207 interior space between covers 204, 206
208 air moving device
209 bottom surface of bottom cover 206
210 impeller
212 connector
214 controller
218 portion of the air moving device 208
220 ports
222 mounting bores
223 attachment feature
224 opening in the second or bottom cover 206
225 domed or raised region
226 air guiding or rib structure
228 mounting bores
227 planar surface of the bottom cover 206
232 mounting bores
236 flange of top cover 204
238 wall of top cover 204
240 top or outer surface of top cover 204
244 inside surface of the bottom cover 206
251 inside surface of top cover 204
256 outside of the bottom cover 206
260 connector, hinge
300 air distribution devices

1. An air distribution device for a vehicle seat, comprising:
a top cover comprising one or more ports;
a bottom cover connected to the top cover to form an air distribution housing, the bottom cover comprising an opening; and
an air moving device comprising an impeller within a housing, the impeller and the housing being located in the air distribution housing between the top cover and the bottom cover;
wherein air is drawn into the air distribution housing by the air moving device through the opening in the bottom cover and then exhausted from the air distribution housing through the one or more ports in the top cover.

2. (canceled)

3. The air distribution device according to claim 1, wherein the air distribution device comprises a rib structure that extends from an inside surface of the bottom cover and contacts an inside surface of the top cover.

4. The air distribution device according to claim 1, wherein the air distribution device is free of any layers inside of the air distribution housing between the top cover and the bottom cover.

5. The air distribution device according to claim 1, wherein the top cover comprises a plurality of ports, and the plurality of ports are laterally offset relative to the opening in the bottom cover, and each of the plurality of ports comprises a flange, and the flange is received into a duct defined in a cushion of the vehicle seat.

6. (canceled)

7. The air distribution device according to claim 5, wherein the air distribution device is configured to be connected to a suspension or frame of the vehicle seat and/or the air distribution device is configured to be received into a recess defined in the cushion of the vehicle seat.

8. The air distribution device according to claim 2, wherein the rib structure comprises a plurality of petals.

9. The air distribution device according to claim 8, wherein the rib structure comprises one or more vertexes.

10. The air distribution device according to claim 9, wherein the rib structure comprises two vertexes and one of the two vertexes are offset from a central horizontal axis of the air distribution housing, or wherein the rib structure comprises two vertexes and one of the two vertexes is aligned with a central horizontal axis of the air distribution housing.

11. (canceled)

12. The air distribution device according to claim 5, wherein the air distribution device comprises ports that are aligned along an axis that is parallel to and offset from a central horizontal axis of the air distribution housing and the central vertical axis of the air distribution device.

13. (canceled)

14. (canceled)

15. (canceled)

16. (canceled)

17. The air distribution device according to claim 1, wherein the top cover, the bottom cover, or both are made of a rigid material.

18. An air distribution device for a vehicle seat, comprising:
a top cover comprising one or more ports;
a bottom cover connected to the top cover to form a housing, the bottom cover comprising an opening; and
an air moving device comprising an impeller, the impeller being located at least partially below the bottom cover;
wherein air is drawn into the housing by the air moving device through the one or more ports in the top cover and then exhausted from the housing through the opening in the bottom cover.

19. The air distribution device according to claim 18, wherein the top cover comprises a rib structure that directs the air from the one or more ports to the one or opening in the bottom cover.

20. The air distribution device according to claim 18, wherein the rib structure extends from an inside surface of the top cover and contacts an inside surface of the bottom cover, and the air distribution device is free of any layers inside of the housing between the top cover and the bottom cover.

21. (canceled)

22. (canceled)

23. (canceled)

24. The air distribution device according to claim 23, wherein the air distribution device is connected to a suspension or frame of the vehicle seat and/or the air distribution device is received into a recess defined in the cushion of the vehicle seat.

25. The air distribution device according to claim 19, wherein the rib structure comprises a plurality of petals and one or more vertexes.

26. (canceled)

27. (canceled)

28) (canceled)

29. (canceled)

30. (canceled)

31. The air distribution device according to claim 18, wherein the air moving device is connected to an outside surface of the bottom cover.

32. (canceled)

33. (canceled)

34. The air distribution device according to claim 36, wherein the top cover, the bottom cover, or both are made of a rigid material.

35. The air distribution device according to claim 18, wherein the bottom cover comprises planar surface and a domed or raised region relative to the planar surface, wherein the impeller is located at least partially within the domed or raised region.

36. The air distribution device according to claim 35, wherein the domed or raised region extends in a direction of the top cover.

37. The air distribution device according to claim 1, wherein the bottom cover comprises planar surface and a domed or raised region relative to the planar surface, wherein the impeller is located at least partially within the domed or raised region.
